(19) United States
(12) Patent Application Publication
(10) Pub. No.: US 2019/0030746 A1
(43) Pub. Date: Jan. 31, 2019

(54) CHAINSAW

(71) Applicant: Koki Holdings Co., Ltd. Intellectual Property Dept, Ibaraki (JP)

(72) Inventor: Kenji NAGANUMA, Ibaraki (JP)

(73) Assignee: Koki Holdings Co., Ltd., TOKYO (JP)

(21) Appl. No.: 16/073,799

(22) PCT Filed: Jan. 6, 2017
(86) PCT No.: PCT/JP2017/000278

§ 371 Date: Jul. 29, 2018

(30) Foreign Application Priority Data
Jan. 30, 2016 (JP) 2016-016775

(51) Int. Cl. B27B 17/08

(52) U.S. Cl. CPC B27B 17/083; B27B 17/02

(57) ABSTRACT

Provided is a chainsaw in which increasing the rotation angle of a brake handle during assembly of component parts around the brake handle facilitates assembling. A chainsaw has a brake mechanism for braking a saw chain via the operation of a brake handle, wherein the housing body side of the chainsaw is provided with: the brake handle, which actuates brakes; a brake link mechanism for actuating the brakes via operation of the brake handle; and a brake spring. A brake link cover for covering the brake mechanism is mounted using screw bosses. A rotation angle limiting member for limiting the rotation range of the brake handle is provided on the brake link cover side. Detaching the brake link cover increases the rotation range of the brake handle.

### TECHNICAL FIELD

The present invention relates to an improvement in a brake mechanism of a chainsaw that rotates and drives an endless saw chain and cuts wood pieces and the like.

### BACKGROUND ART

Chainsaws using a small engine and an electric motor as a power source are widely known. An engine chainsaw includes a centrifugal clutch. When a rotation speed of a drive shaft exceeds a set value, a centrifugal clutch is connected, power is transmitted from the drive shaft to a sprocket, and a saw chain rotates. When a rotation speed of the drive shaft is less than a set value, the centrifugal clutch is blocked, power transmission from the drive shaft is blocked and the saw chain remains in a stop state.

When rebounding of a chainsaw occurs while an object such as a wood piece is being cut or when rotation of a saw chain is desired to be immediately stopped for some reason, an operator can stop rotation of the saw chain by tilting a brake lever disposed on the front side of a front handle forward and operating a brake mechanism. For example, a brake mechanism is disclosed in Patent Literature 1, and a brake mechanism that is operated by a brake lever is a mechanical brake, a brake band is disposed on the outer circumferential side of a rotating body that rotates in connection with a sprocket, the brake band is strongly fastened using a link mechanism when the brake lever is operated and thus rotation of the rotating body is stopped.

### CITATION LIST

### Patent Literature

### [Patent Literature 1]

Japanese Unexamined Patent Application Publication No. 2013-144422

### SUMMARY OF INVENTION

### Technical Problem

In chainsaws in the related art, since a rotation angle of a brake handle (brake operation unit) is limited when a part of the brake handle hits on a stopper part formed on a housing body, the rotation angle is restricted to being small. Such a configuration is convenient because a movement angle of the brake handle is restricted during use. However, during production and assembling, since a brake link mechanism is assembled while pulling a brake spring, there are problems that it is necessary to use a special tool and the assembling performance is not favorable.

The present invention has been made in view of the above background, and an object of the present invention is to provide a chainsaw in which the assembling performance of a brake link mechanism is improved by allowing a rotation angle of a brake handle to be increased when constituent components around the brake handle are assembled. Another object of the present invention is to provide a chainsaw in which a rotation angle limiting member of a brake handle is provided separately from a housing and thus it is possible to freely restrict an operation angle of the brake handle after assembling. Still another object of the present invention is to realize a chainsaw in which a sufficient strength for a rotation angle limiting mechanism that receives a rotation torque of a brake handle can be ensured.

### Solution to Problem

Representative aspects among inventions disclosed in this specification will be described as follows. According to one aspect of the present invention, there is provided a chainsaw including a driving source configured to drive a saw chain; a brake configured to stop rotation of the saw chain provided on a side of a housing body including the driving source; a brake operation unit configured to allow operation of the brake; and a brake link configured to allow operation of the brake according to an operation of the brake operation unit, wherein the brake link is provided on the side of the housing body and a movement amount limiting unit configured to restrict an operation amount of the brake operation unit is detachable from the housing body. The brake operation unit is pivotally supported by the housing body so that it can be rotated by an operator, and the movement amount limiting unit is a rotation angle limiting member that limits a rotation range of the brake operation unit. In this manner, when the rotation angle limiting member of the brake operation unit is configured as a detachable component separately from a brake handle or a base (such as a housing) on which the brake handle is mounted, since a rotation angle of the brake operation unit can be set to be large while constituent components (such as a link and a spring) around the brake are assembled, the assembling performance is greatly improved.

According to another aspect of the present invention, the brake link is biased in a predetermined direction by an elastic body such as a brake spring. The rotation angle limiting member does not operate during an operation of mounting the elastic body on the brake link but it operates after the spring is mounted. In addition, a brake link cover that covers an accommodation unit of the brake link of the housing body and is fixed is provided and the rotation angle limiting member is provided in the brake link cover. When the rotation angle limiting member is provided as a separate component, the angle at the time of brake operation of the brake operating portion after assembly can be freely set, and it is possible to easily support dimensional specifications of the brake operation unit and the like. In addition, in this structure, since a rotation limiting member receives a rotation torque of the brake operation unit, it is easy to increase the strength and it is easy to support rotation strength specifications of the brake operation unit.

According to still another aspect of the present invention, the rotation angle limiting member is a protrusion provided to protrude from the brake link cover to the vicinity of a rotation point of the brake operation unit. In addition, the elastic body is assembled while the brake link cover is removed and is assembled while the brake operation unit is rotated beyond a range of an operation amount limited by the rotation angle limiting member. In particular, a rotation range of the brake operation unit during an operation of mounting the elastic body on the brake link is increased to be larger than a rotation range of the brake operation unit during operation, and the increased rotation range is set on a side on which the brake mechanism allows operation of the brake operation unit. In this manner, in the structure, since the rotation angle limiting member receives a rotation torque of the brake handle, it is easy to increase the strength and it is easy to support rotation strength specifications of the brake handle.

### Advantageous Effects of Invention

According to the present invention, when constituent components around the brake handle are assembled, since a rotation angle of the brake handle increases, the assembling performance of the brake link mechanism can be greatly improved. In addition, when the rotation angle limiting member of the brake operation unit is provided as a component separately from the housing body, it is possible to freely restrict an operation angle of the brake handle after assembling.

The above and other objects of the present invention and new aspects can be clearly understood from the following description and drawings in this specification.

### BRIEF DESCRIPTION OF DRAWINGS

FIG. 1 is a right side view of a chainsaw according to an example of the present invention.

FIG. 2 is a right side view of a chainsaw 1 while a side cover 5 in FIG. 1 is removed.

FIG. 3 is a partial side view (partial cross-sectional view) of a brake mechanism accommodation unit of the chainsaw according to the example of the present invention.

FIG. 4 is a perspective view of the brake mechanism accommodation unit of the chainsaw according to the example of the present invention.

FIG. 5 is a side view for explaining an operation of a brake link mechanism in FIG. 2.

FIG. 6 is a diagram for explaining procedures when a spring of the brake link mechanism is assembled.

FIG. 7 shows side views showing a shape of a brake link cover, (1) is a diagram when viewed from the outside and (2) is a diagram when viewed from the reverse side.

### DESCRIPTION OF EMBODIMENTS

### Example 1

Examples of the present invention will be described below with reference to the drawings. Here, in the following drawings, the same parts will be denoted with the same reference numerals and repeated descriptions will be omitted. In addition, in this specification, front and rear, and up and down directions are directions shown in the drawings.

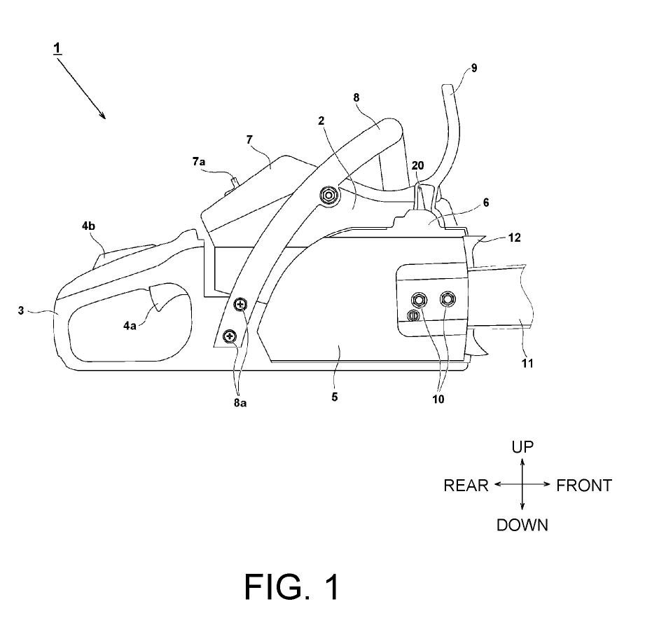

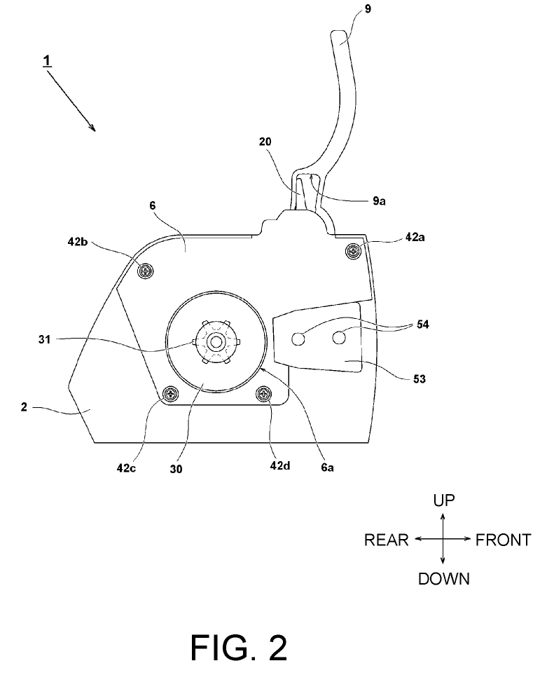

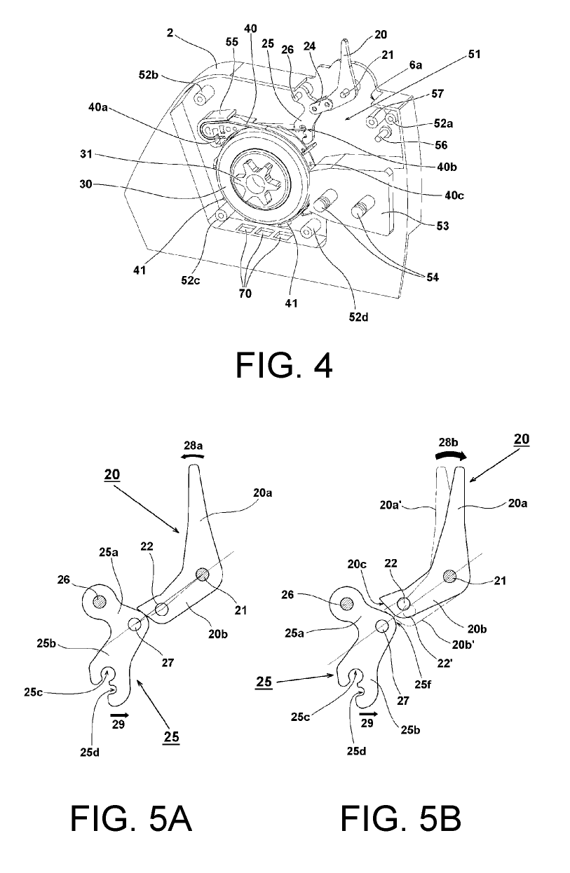

FIG. 1 is a right side view of a chainsaw 1 according to an example of the present invention. The chainsaw 1 cuts trees and branches by rotating a saw chain (not shown) that rotates around a guide bar 11 at a high speed using a 2-cycle engine (to be described below). The engine is accommodated in a housing body 2, and the guide bar 11 is disposed such that it extends forward from the right side surface of the housing body 2. The engine is accommodated in the housing body 2, and the guide bar 11, handles, covers, and a spike 12 are mounted around the housing body 2, and thus the housing body 2 serves as a framework part of the chainsaw 1. In the present example, a space for accommodating a brake link mechanism is formed in a part of the housing body 2, and the space is covered by a brake link cover 6. A saw chain traveling space in which a sprocket (to be described below with reference to FIG. 2) rotates is formed outside the brake link cover 6, and the saw chain traveling space is covered by a side cover 5. The side cover 5 is fixed by a mounting bolt 54 (to be described below with reference to FIG. 4) provided in the housing body 2 and a mounting nut 10 mounted in the mounting bolt 54.

A front handle 8 that is held by an operator is fixed to the housing body 2 by a plurality of screws 8a and a rear handle 3 is provided on the rear side. One side end of the front handle 8 is fixed to the right side of the housing body 2 and the other side end is fixed to the left side. In the rear handle 3, a throttle lever 4a configured to allow operation a vaporizer (not shown) and adjust an output of the engine and a lock lever 4b configured to release locking of the throttle lever 4a are provided. On the front side of the front handle 8, a brake handle (hand guard) 9 as a brake operation unit is provided. When the brake handle 9 is tilted and rotated from a position shown in FIG. 1 to the front side, the rotation of the saw chain can be instantaneously stopped. The brake handle 9 is pivotally supported by the housing body 2 and can rotate in a front and rear direction by a predetermined angle. A large opening is provided on the upper side of the housing body 2 and a top cover 7 that is removable by a fixing screw 7a is mounted thereon.

In the not shown engine, a crankshaft (not shown) that extends in a left and right direction perpendicular to the front and rear direction of the chainsaw 1 is disposed inside the housing body 2, and a cooling fan and a recoil starter (both are not shown) are provided at the left side end of the crankshaft. A centrifugal clutch mechanism is provided at the right side end of the crankshaft, and the sprocket (to be described below) is mounted on a rotating drum of the centrifugal clutch mechanism. When the operator starts the engine and pulls the throttle lever 4a provided in the rear handle 3, the rotation of the engine becomes fast, the centrifugal clutch (not shown) is connected, a rotation force of the engine is transmitted, and the saw chain (not shown) rotates. In order to stop the engine during operation, a not shown stop switch provided in a part of the housing body 2 is turned off.

FIG. 2 is a partial side view of the chainsaw 1 while the side cover 5 in FIG. 1 is removed. Here, only a part of the housing body 2 covered with the side cover 5 is shown. The brake handle 9 that extends upward is rotatably held in the housing body 2. The brake link mechanism is accommodated in a right side rotation part of the brake handle 9, but the brake link mechanism is covered by the brake link cover 6 that is fixed by four screws which are four mounting screws 42a to 42d. The brake link cover 6 has an opening 6a having a size corresponding to a clutch drum 30, and a sprocket 31 is mounted on a drive shaft 15 that protrudes from the opening 6a to the right side. In a part of the housing body 2 on the front side of the sprocket 31, a mounting part 53 for fixing the not shown guide bar 11 is formed and two mounting bolts 54 are provided thereon.

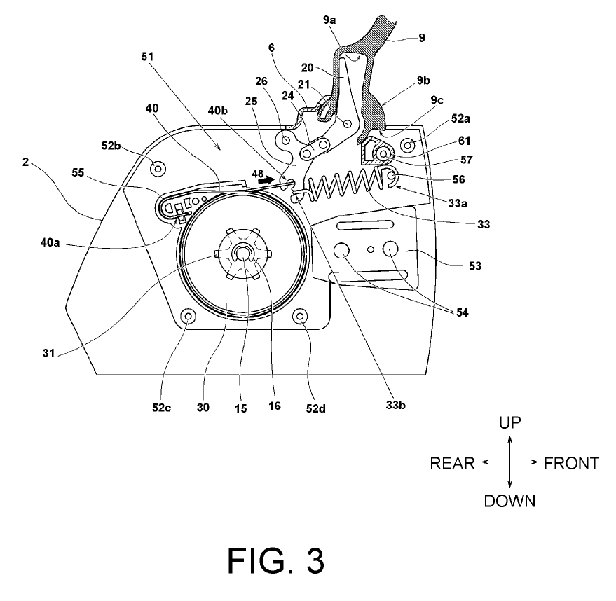

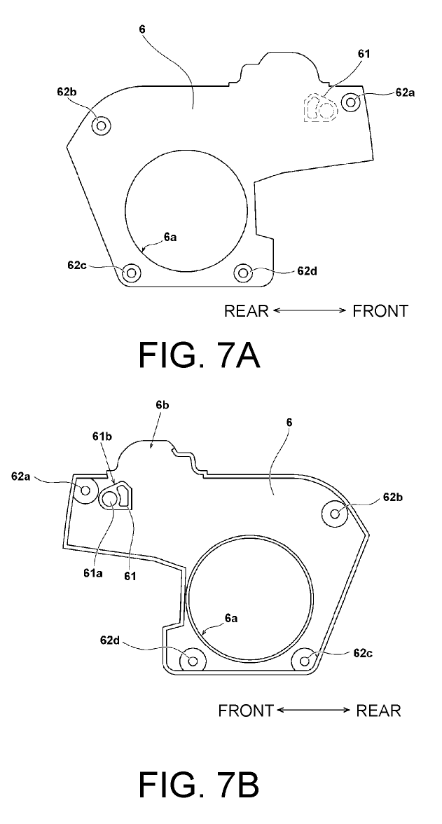

FIG. 3 is a diagram showing a state in which the brake link cover 6 is removed in the state in FIG. 2. However, FIG. 3 is a diagram substantially corresponding to a state in which the brake link cover 6 is removed, but a cross-sectional shape of the brake link cover 6 in the vicinity of the upper side of an operation plate 25 and a cross-sectional shape of a rotation limiting member 61 are shown as an illustration. A mechanical brake mechanism is provided in the chainsaw 1 according to the present example. The brake mechanism applies braking to the rotation of the saw chain, and includes a belt-like brake band 40 wound around the outer circumference of the clutch drum 30 of the centrifugal clutch, link mechanisms 20, 24, and 25 that wind or unwind the brake band 40 on and from the clutch drum 30, and a brake spring 33 that biases the link mechanism in a predetermined direction. In the housing body 2, a part recessed inward to accommodate the brake mechanisms 20, 24, 25, and 33, the clutch drum 30, and a rotation limiting member mounting shaft 57, that is, a recess 51, are formed. The outer edge of the recess 51 corresponds to the outer edge shape of the brake link cover 6 (refer to FIG. 2 and FIG. 7 to be described below) in the side view shown in FIG. 3. In addition, four screws bosses 52a to 52d for the brake link cover 6 to be screwed onto are formed at four parts in the vicinity of the outer circumferential edge of the recess 51 of the housing body 2.

The clutch drum 30 is a cylindrical member having a predetermined width in the axis direction and acts as a mechanical brake mechanism by the brake band 40 being wound on its outer circumferential surface. The brake band 40 is a belt-like member made of metal and has one end side that is bent in a U shape, and a needle 40a for holding is formed in the vicinity of a tip to prevent the brake band 40 from escaping. The brake band 40 is bent into a circular shape in a side view and a hook part formed at the other end 40b is locked by the brake link mechanism. In order to brake the clutch drum 30 by the brake band 40, the brake link mechanism is operated, the brake band 40 is pulled in a direction of an arrow 48, the diameter of the brake band 40 along the outside of the clutch drum 30 decreases and the brake band 40 is brought into close contact with the clutch drum 30. When the brake is released, if a pulling force in a direction of the arrow 48 is released, the diameter of a circular part is increased by a restoring force of the brake band 40, and the force that fixes the clutch drum 30 is released.

The brake handle 9 is pivotally supported by the housing body 2, and a right side mounting part thereof is rotatable in a front and rear direction by a rotation shaft 21. Inside a right side mounting part of the brake handle 9, a swing space 9a is provided, and one end side with respect to the rotation shaft 21 of a reset plate 20 is accommodated therein as an operation part of the link mechanism. The swing space 9a is provided in this manner and a part of the reset plate 20 is accommodated therein in order to set a rotation angle of the brake handle 9 to be larger than a rotation angle of the reset plate 20 with respect to the rotation shaft 21. The operation plate 25 is substantially an L-shaped member that swings and is pivotally supported by a rotation shaft 26. At a tip of an arm part, a locking part for locking the end 40b of the brake band 40 is formed, and additionally, a locking part for locking a hook part 33b on one end side of the brake spring 33 is formed. A swinging end of the reset plate 20 and the vicinity of a bent part of the operation plate 25 are linked by a connecting plate 24.

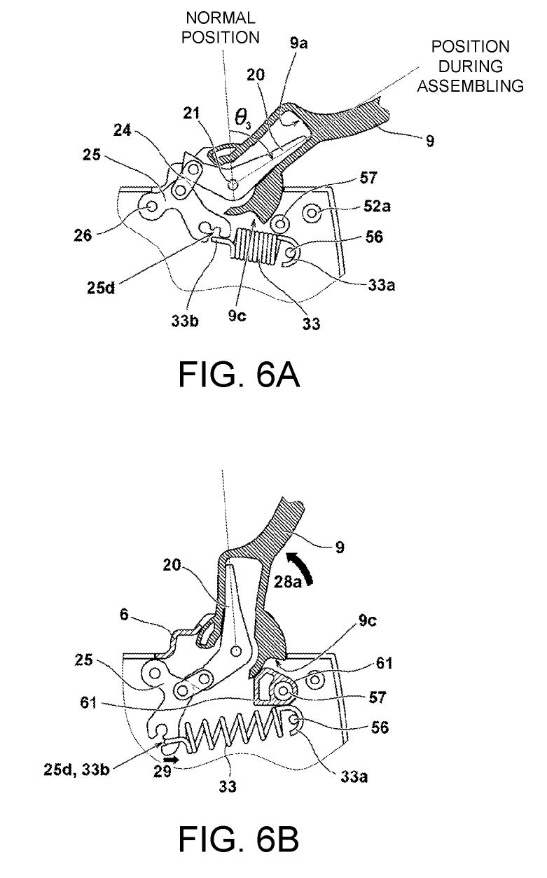

A rotation angle of the brake handle 9 to the front side is limited by abutting a stopper wall 9c formed on one end side in a circumferential direction of a cylindrical shaft 9b in the vicinity of the rotation shaft 21 of the brake handle 9 against the rotation limiting member 61. The rotation limiting member 61 is a movement amount limiting unit configured to restrict an operation amount of a brake operation unit and is integrally produced with the brake link cover 6 made of a synthetic resin. When the brake link cover 6 is removed, the rotation limiting member 61 is also removed. A hook part 33a as the other end of the brake spring 33 locked on the operation plate 25 is locked on a brake spring holding shaft 56 formed in the housing body 2. The brake spring 33 is an elastic body made of a tension coil spring and the hook parts 33a and 33b are formed at both ends. The brake spring 33 applies a force that fixes the brake band 40 in a direction of the arrow 48 while the brake is operated, and on the other hand, when the brake is not being operated by the link mechanism, the brake handle is returned to an initial position shown in FIG. 3 by the brake spring 33. The operation principle of the brake spring 33 will be described below in detail with reference to FIG. 5.

FIG. 4 is a perspective view of a brake mechanism of the chainsaw 1 according to an example of the present invention. FIG. 4 shows a state in which the brake handle 9 and the brake spring 33 are removed in the state in FIG. 3, and also shows a state in which the brake link cover 6 and the rotation limiting member 61 integrally formed therewith are completely removed. The reset plate 20 and the operation plate 25 arc plate-like members made of metal, and parts thereof are linked by two connecting plates 24 on both sides. The connecting plate 24 has the same function as one frame of a roller chain and the reset plate 20 and the operation plate 25 are linked by two connecting pins provided on both sides.

In the brake band 40 wound around the clutch drum 30 that rotates, a circular hole 40c is formed in a part that is in contact with the outer circumferential surface of the clutch drum 30. The hole 40c is formed in order to improve a heat radiation effect, and a plurality of holes 40c are provided in the circumferential direction at constant or irregular intervals. On the outer circumferential side of the brake band 40, a plurality of ribs 41 for holding the shape are provided when the brake band 40 is loosened and the size in the radial direction becomes large. In addition, in order to release heat generated when the brake is operated, a plurality of air holes 70 are provided in a lower surface part of the recess 51 of the housing body 2. Although not shown in this specification, if an air flow window is opened in the vicinity of an upper end of the brake link cover 6, since a window through which air flows is formed on the lower side and the upper side of the brake mechanism, it is possible to effectively release heat generated when the brake is operated to the outside. The housing body 2 is produced by integrally molding a synthetic resin. Therefore, not only the mounting part 53 on which the guide bar 11 is mounted, but also the screw bosses 52a to 52d, a mounting guide 55, the rib 41, the rotation limiting member mounting shaft 57, and the like are integrally formed. The mounting bolt 54 for mounting the guide bar 11 is provided in the mounting part 53 by casting.

When the operator tilts the brake handle 9 to the front side (brake operation direction), since the reset plate 20 is also tilted in the same direction, one end side of the brake band 40 wound around the clutch drum 30 is pulled by the operation plate 25 and thus rotation of the clutch drum 30 is stopped. Since the sprocket 31 and the saw chain are linked to the clutch drum 30, rotation of the saw chain is stopped according to the stopping of the clutch drum 30. When the brake handle 9 is returned to the rear by the operator from this state, since the brake handle 9 and the reset plate 20 are stably held at the initial position by a biasing force of the brake spring 33, fastening of the clutch drum 30 by the brake band 40 is loosened, and the clutch drum 30, the sprocket 31, and the saw chain can freely rotate.

Next, an operation of the brake link mechanism will be described with reference to FIG. 5. Here, it should be noted that the connecting plate 24 is not shown. FIG. 5(1) shows a state in which the brake is not being operated, and FIG. 5(2) shows a state in which the brake is being operated. The reset plate 20 is substantially an L-shaped plate component having a gentle angle when viewed in the axis direction and can be swing in a direction of an arrow 28b from the state (1) to (2) using the rotation shaft 21 as a center. A first arm 20a is provided to extend on one side of the reset plate 20 when viewed from the rotation shaft 21, and a second arm 20b is provided to extend on the other side. The operation plate 25 is a plate component in which a first arm 25a and a second arm 25b are linked in substantially an L-shape when viewed in the axis direction and is pivotally supported on the housing body 2 by the rotation shaft 26 provided at an end. In the vicinity of a part that connects the first arm 25a and the second arm 25b, a connecting pin 27 pivotally supported with an end of the connecting plate 24 (refer to FIG. 3) is provided. The other end of the connecting plate 24 is pivotally supported by a connecting pin 22 at an end of the second arm 20b of the reset plate 20. Since connection is performed by the connecting plate 24 in this manner, the reset plate 20 and the operation plate 25 rotate while being mutually influenced.

In the vicinity of a tip of the second arm 25b of the operation plate 25, a locking part 25c for locking the brake band 40 and a locking part 25d for locking the brake spring 33 (refer to FIG. 3) are formed. The brake spring 33 locked on the locking part 25d transmits a compressive force in a direction of an arrow 29. In this case, when the brake is not being operated as in (1), the connecting pin 22 is positioned on a brake spring 33 side of an imaginary line connecting the centers of the connecting pin 27 and the rotation shaft 21, and an oblique shape of the end of the second arm 20b of the reset plate 20 is formed at the part of an arrow 20c. Therefore, when a force in a direction of the arrow 29 in FIG. 5(1) is applied, the reset plate 20 is impelled to rotate in a direction of an arrow 28a, but it cannot rotate due to the positional relationship between the connecting plate 24 and an oblique part 20c, and the reset plate 20 and the operation plate 25 are stably held at the position in FIG. 5(1), and the brake spring 33 is also held in a pulled state.

When the operator tilts the brake handle 9 forward from the state (1), the reset plate 20 rotates from a position of 20a′ to a position of 20a in (2). Since this rotation is centered on the rotation shaft 21, the second arm 20b also rotates from a position of 20b′ and a position of the connecting pin 22 is moved from 22′ and is moved to an upper side part from an imaginary line connecting the centers of the connecting pin 27 and the rotation shaft 21, that is, a side away from the brake spring 33. As a result, since the second arm 20b is rotated in a direction away from the connecting pin 22 by a corner 25f of the operation plate 25, a holding state of the reset plate 20 is released, a pulling force of the brake spring 33 is released, the second arm 25b pulls one end side of the brake band 40, the clutch drum 30 is fastened, and thus rotation of the clutch drum 30 is stopped. An amount of movement of the operation plate 25 counterclockwise is restricted to an extent of the brake band 40 being pulled.

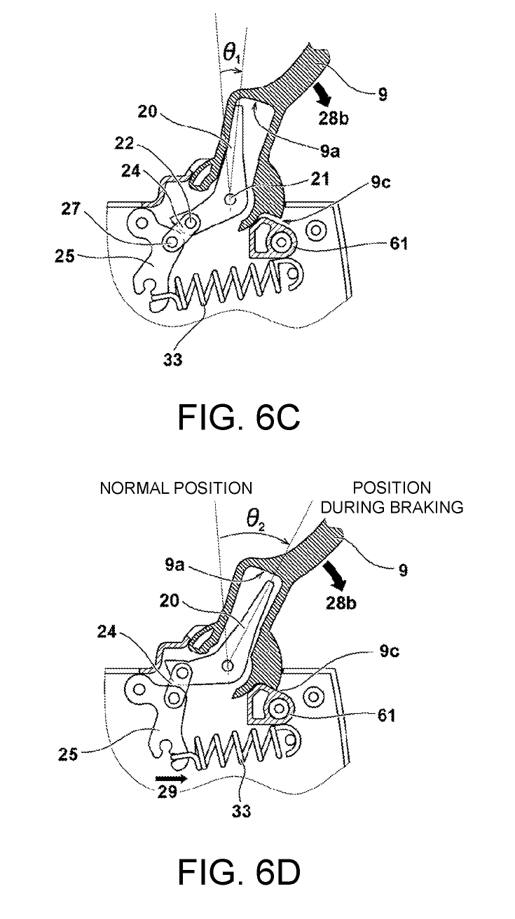

Next, procedures of assembling the brake spring 33 will be described with reference to FIG. 6. In the present example, a rotation range θ₃ (refer to FIG. 6(1)) of the operation plate 25 during the operation of mounting the brake spring 33 on the brake link mechanism is increased to be larger than a rotation range θ₂ (refer to FIG. 6(4)) of the operation plate 25 when the chainsaw 1 is operated (when a driving source rotates), and the increased rotation range is set on a side on which the brake is operated, that is, the front side. FIG. 6(1) shows a state of the brake link mechanism when the brake spring 33 is assembled and the brake handle 9 greatly rotates to the front side. The hook part 33a of the brake spring 33 in this state is locked on the brake spring holding shaft 56, and the hook part 33b is then locked on the locking part 25d of the operation plate 25. In this case, since rotation of the reset plate 20 and rotation of the operation plate 25 increase, the locking part 25d can be brought significantly closer to the side of the brake spring 33 (the front side) than during a general operation.

A person who performs an assembling operation can easily lock the hook part 33b and the locking part 25d without strongly pulling the brake spring 33. Here, in (1) in the drawing, a procedure in which the hook part 33a is locked first and the hook part 33b is then locked is shown, but the order may be reversed and the hook part 33b may be locked first. In addition, in FIG. 6(1) to 6(4), the brake band 40 is not locked on the locking part 25c, but the brake band 40 may be mounted before the brake spring 33 is assembled. However, such assembling procedures are arbitrary, and the brake band 40 may be mounted after the brake spring 33 is assembled. The brake band 40 can be easily pulled before the clutch drum 30 is mounted and can be easily mounted on the brake link mechanism.

FIG. 6(2) is a diagram showing a state in which the brake spring 33 is assembled, the brake handle 9 is positioned at a normal position, and the brake link cover 6 is mounted on the housing body 2. Since the rotation limiting member 61 is integrally formed on the brake link cover 6, when the brake link cover 6 is mounted on the housing body 2, the rotation limiting member 61 is positioned on the lower side of the stopper wall 9c of the brake handle 9. In the state in FIG. 6(2), a pulling force of the brake spring 33 is applied to the operation plate 25, and the force is applied in a direction of the arrow 29. However, since the brake link mechanism is in the state in FIG. 5(1), it is stably held in a state in which the brake is not locked. Here, the shape of the brake link cover 6 will be described with reference to FIG. 7.

FIG. 7 shows side views of the shape of the brake link cover 6, (1) is a diagram when viewed from the outside and (2) is a diagram when viewed from the reverse side. The brake link cover 6 is produced by integrally molding a synthetic resin such as a plastic and is a cover that covers an opening formed by a recessed part 51 of the housing body 2. In the brake link cover 6, the opening 6a having a diameter that is slightly larger than an outer diameter of the clutch drum 30 is formed in order to allow the sprocket 31 linked to the clutch drum 30 to extend (refer to FIG. 3). In the vicinities of four corners of the brake link cover 6, screw holes 62a to 62d through which the mounting screws 42a to 42d (refer to FIG. 2) penetrate are formed.

FIG. 7(2) is a diagram of the brake link cover 6 when viewed from the inside (a diagram of the rear surface). In almost the entire part except for a part of the outer circumferential edge of the brake link cover 6 (near an arrow 6b) and the outer edge of the opening 6a, a wall surface that extends in a direction parallel to a rotational axis direction of the clutch drum 30 is formed. Since the vicinity of the arrow 6b is a part in which the brake handle 9 is positioned, a wall surface thereof is not formed. In the vicinity of the screw hole 62a, the rotation limiting member 61 that is a protrusion provided to protrude to near a rotation point of the brake handle 9 is provided. An upper surface 61b of the rotation limiting member 61 is formed into a shape that abuts the entire surface of the stopper wall 9c of the brake handle 9 (refer to FIG. 3). In addition, on the front side of the rotation limiting member 61, an axial cylindrical hole 61a into which the rotation limiting member mounting shaft 57 (refer to FIG. 4) is inserted is formed. Since the rotation limiting member 61 is integrally molded with a synthetic resin together with the brake link cover 6, the upper surface 61b and the axial cylindrical hole 61a are also produced by molding. Here, while the rotation limiting member 61 is made of a synthetic resin in the present example, a rotation limiting member 61 that is made of metal may be produced by casting it into the brake link cover 6 made of a synthetic resin, or the rotation limiting member 61 may be separately produced and may be mounted on the brake link cover 6 by an arbitrary method such as screwing, fitting, or adhesion. In any case, in a configuration in which the rotation limiting member 61 is also automatically mounted when the detachable brake link cover 6 is mounted on the housing body 2, it is possible to reliably prevent mounting of the rotation limiting member 61 from being forgotten. In such a structure, when the brake link mechanism is assembled and during the operation of mounting the brake spring 33, since the rotation limiting member 61 is not provided, the rotation limiting member 61 does not operate. As a result, since the brake handle 9 can be rotated greatly to an angle θ₃ shown in FIG. 6(1), the brake spring 33 can be easily mounted. Description will return to FIG. 6 again.

In FIG. 6(2), in the rotation limiting member 61, the axial cylindrical hole 61a (refer to FIG. 7) along the outer shape of the cylindrical rotation limiting member mounting shaft 57 is formed. When the brake link cover 6 is mounted, since the axial cylindrical hole of the rotation limiting member 61 enters the rotation limiting member mounting shaft 57, the rotation limiting member 61 is stably held not only by the brake link cover 6 but also from the side of the housing body 2.

FIG. 6(3) is a diagram showing a state in which the operator starts an operation of a manual brake, that is, a state immediately after the brake handle 9 is pushed to the front side. The state of the brake link mechanism in FIG. 6(3) corresponds to the state in FIG. 5(2), and when the brake handle 9 is moved in a direction of the arrow 28b, the reset plate 20 is also moved in the same direction. Then, a position of the connecting pin 22 of the connecting plate 24 is changed from the side of the brake spring 33 of an imaginary line connecting the centers of the connecting pin 27 and the rotation shaft 21 to the opposite side, and thus a pulling force of the brake spring 33 is applied and movement of the operation plate 25 in a direction of the arrow 29 rapidly starts. Then, when the state is brought into a state in FIG. 6(4), the stopper wall 9c of the brake handle 9 abuts the rotation limiting member 61. That is, a rotation angle of the brake handle 9 can be limited by the rotation limiting member 61. Since the swing space 9a is formed in the brake handle 9, a rotation angle of the reset plate 20 up to θ₂ is allowed with respect to a rotation angle of the brake handle 9, and thus the clutch drum 30 can be reliably braked by fastening of the brake band 40.

As described above, in the present example, the brake handle 9, the housing body 2, and the rotation limiting member 61 configured to limit a rotation angle of the brake handle 9 are configured as separate components other than a component (here, the housing body 2) on the side on which the brake handle 9 is pivotally supported. Therefore, when constituent components (such as the brake spring 33) around the brake are assembled, constituent components can be assembled while the brake handle 9 is greatly rotated beyond a range of an operation amount to be limited. Then, when the rotation limiting member 61 is mounted, a rotation angle of the brake handle 9 can be restricted to being small. In addition, when the rotation limiting member 61 is provided on the side of the brake link cover 6, since the rotation limiting member 61 can also be mounted at the same time by mounting the brake link cover 6 on the housing body 2, there is no risk of mounting of the rotation limiting member 61 being forgotten. Furthermore, since the rotation limiting member 61 that receives a rotation torque of the brake handle 9 is held not only by the brake link cover 6 but also by the rotation limiting member mounting shaft 57 on the side of the housing body 2, a sufficient strength for the rotation limiting mechanism can be ensured.

While the present invention has been described above with reference to the example, the present invention is not limited to the above example, and various modifications can be made without departing from the spirit and scope of the present invention. For example, the mounting structure of the brake band and the configuration of the brake link mechanism are not limited to those of the above example, and other configurations may be used, and when the rotation limiting member is provided on the side of a separate member other than a part to which the brake handle is fixed, it can be similarly applied to a chainsaw using another brake mechanism.

### REFERENCE SIGNS LIST

1 Chainsaw
2 Housing body
3 Rear handle
4a Throttle lever
4b Lock lever
5 Side cover
6 Brake link cover
6a Opening
7 Top cover
7a Fixing screw
8 Front handle
8a Screw
9 Brake handle
9a Swing space
9b Shaft
9c Stopper wall
10 Nut
11 Guide bar
12 Spike
15 Drive shaft
16 Retaining ring
20 Reset plate
20a First arm
20b Second arm
21 Rotation shaft
22 Connecting pin
24 Connecting plate
25 Operation plate
25a First arm
25b Second arm
25c, 25d Locking part
25f Corner
26 Rotation shaft
27 Connecting pin
30 Clutch drum
31 Sprocket
33 Brake spring
33a, 33b Hook part
40 Brake band
40a Needle
40b End
40c Hole
41 Rib
42a to 42d Mounting screw
51 Recessed part
52a Screw boss
53 Mounting part
54 Mounting bolt
55 Guide
56 Brake spring holding shaft
57 Rotation limiting member mounting shaft
61 Rotation limiting member
61a Axial cylindrical hole
62a to 62d Screw hole
70 Air hole

1. A chainsaw comprising:
a driving source configured to drive a saw chain;
a brake configured to stop rotation of the saw chain provided on a side of a housing body including the driving source;
a brake operation unit configured to allow operation of the brake; and
a brake link configured to allow operation of the brake according to an operation of the brake operation unit,
wherein the brake link is provided on the side of the housing body and a movement amount limiting unit configured to restrict an operation amount of the brake operation unit is detachable from the housing body.

2. The chainsaw according to claim 1,
wherein the brake operation unit is rotatably and pivotally supported by the housing body, and
the movement amount limiting unit is a rotation angle limiting member that limits a rotation range of the brake operation unit.

3. The chainsaw according to claim 2,
wherein the brake link is biased in a predetermined direction by an elastic body, and
the rotation angle limiting member does not operate during an operation of mounting the elastic body on the brake link, but it operates after the elastic body is mounted.

4. The chainsaw according to claim 3,
wherein a brake link cover that covers an accommodation unit of the brake link of the housing body and is fixed is provided and the rotation angle limiting member is provided in the brake link cover.

5. The chainsaw according to claim 4,
wherein the rotation angle limiting member is a protrusion provided to protrude from the brake link cover to the vicinity of a rotation point of the brake operation unit.

6. The chainsaw according to claim 5,
wherein the elastic body is assembled while the brake link cover is removed and is assembled while the brake operation unit is rotated beyond a range of an operation amount limited by the rotation angle limiting member.

7. A chainsaw comprising:
a driving source configured to drive a saw chain;
a brake mechanism configured to stop rotation of the saw chain provided on a side of a housing body including the driving source;
a rotary type brake operation unit configured to allow operation of the brake mechanism; and
a brake link configured to allow operation of the brake mechanism according to an operation of the brake operation unit,
wherein the brake link is biased in a predetermined direction by an elastic body, a rotation range of the brake operation unit during an operation of mounting the elastic body on the brake link is increased to be larger than a rotation range of the brake operation unit during operation, and the increased rotation range is set on a side on which the brake mechanism allows operation of the brake operation unit.

8. The chainsaw according to claim 7,
wherein the rotation range of the brake operation unit is restricted by a rotation angle limiting member that is mounted after the elastic body is mounted on the brake link and limits an operation amount of the brake operation unit.

9. The chainsaw according to claim 8,
wherein a side cover is provided on an accommodation unit of the brake mechanism of the housing body,
the brake mechanism is provided on one of the housing body and the side cover, and
the rotation angle limiting member is provided on the other one of the housing body and the side cover.

10. The chainsaw according to claim 4,
wherein the elastic body is assembled while the brake link cover is removed and is assembled while the brake operation unit is rotated beyond a range of an operation amount limited by the rotation angle limiting member.
